(19) United States
(12) Patent Application Publication
(10) Pub. No.: US 2003/0160669 A1
(43) Pub. Date: Aug. 28, 2003

(54) Magnetic and mechanical switches

(76) Inventor: Christian Trandafir, St-Laurent (CA)

Correspondence Address: David T. Bracken, The Law Office of David T. Bracken, 4839 Bond Avenue, Orange, CA, 92869, US

(21) Appl. No.: 10/081,875

(22) Filed: Feb. 22, 2002

(51) Int. Cl. H01H 51/22; H01H 9/00

(52) U.S. Cl. 335/78

(57) ABSTRACT

The embodiments of the invention include tactile response spring type switches and magnetic connection release switches, especially those switches adapted with backlighting.

### BACKGROUND OF THE INVENTION

The present invention relates to mechanical and/or magnetic switches, especially those overlain with a membrane for sealing electrical devices against an atmosphere.

Back lighting structures of membrane switches in the prior art have either been inefficient in terms of electrical consumption versus milicandela produced, and/or have been overly complex in their construction and therefore costly to produce. The following are examples of overly complex approaches to back lighting: Electro Luminescent (EL Lamps), that require expensive and noisy current inverters; reflectors or fiber mesh layers that channel indirect light to the button; light pipes that transmit light from a distant source to the back of each button by way of bundled glass fibers; clusters of LEDs placed around the edges of the buttons that require added circuits. An important design of a membrane switch is that is should have a fluid tight seal against the atmosphere, a difficult goal since pushbuttons must be activated by pressure on the membrane. Prior art devices often have interstices in and around the buttons that provide an area for microbes and/or viruses to multiply. Other back-lighting methods can drastically reduce the tactile feedback of the keys. This particular problem is usually caused, by the need to add supplementary layers above the opaque armatures or domes, due to the need to indirectly channel light from an offside light or lights, this method can result in a larger current draw per milicandella. Other backlit membrane switches incorporate a single layer light source such as an EL Lamp, which illuminates all the buttons at the same time, require expensive electronic inverters. EL lamps generally suffer from a very short service life. The present invention provides a very higher milicandela rating with lower power consumption, and by being separately addressable, allowing for selective lighting and also, for the use of bi or tri-colored light sources. U.S. Pat. No. 5,990,772 discloses an electrical switch with a substrate with at least one pair of spaced switch contacts arranged to be shorted by an electrically conductive armature. The armature, basically a circular piece of metal, has a central axis with first and second portions on either axis side. The armature is normally held spaced from the contacts by magnetic attraction to a coupler layer. The armature is intended to be pressed downward toward the substrate. The armature separates from the coupler layer by a double pivoting motion. An actuating force applied to the armature remote from its central axis causes one edge of the armature nearest the actuating force to break away from the coupler layer. The armature then pivots about the opposite edge of the armature until the one edge bottoms on the substrate. This is followed by the opposite edge of the armature breaking away from the coupler layer and pivoting about the one edge until the opposite edge bottoms on the substrate.

This action is well known in the art. It is shown in U.S. Pat. No. 4,211,991 in its FIG. 6 that a user pressing on the outer edge the button top 20 will cause a portion of armature magnets 4a, 5a and 6a to be depressed toward the substrate switch contacts 21 or 22 while the armature magnets 4a, 5a and 6a beneath the other side of the button top 20 will be maintained in magnetic connection with the coupler layer 9. The sole invention of U.S. Pat. Nos. 5,990,772 appears to be in providing the additional armature extension 82 on the bottom outside edge in combination with a substantially offset topside extension 74 (as in its FIG. 2) so that the function of “double pivoting” may be accomplished. Substantial double pivoting patentably distinct from U.S. Pat. No. 4,211,991 appears to require both such placed extension to the armature of U.S. Pat. No. 5,990,772.

There is a need for a magnetic switch that permits the user to have effect backlighting. Although U.S. Pat. No. 5,990,772 describes that merely making a hole in the armature will permit backlighting, such a simple adaptation as attempted by the patentee of U.S. Pat. No. 5,990,772 has heretofore been unsuccessful. The present invention provides for several forms of mechanical and magnetic switches which may be backlighted.

A very valuable feature supposedly achieved by the device claimed in U.S. Pat. No. 5,990,772 is a “tactile” switch. The double pivoting action apparently, in a low profile button switch, allows the user to tactilely feel not the effect of the first pivot action, i.e., the contact of the bottom side extension with the substrate but rather the user feels the substantial and sudden “flop” of the opposite side of the armature breaking away from the magnet connection across a substantial distance. That substantial distance, in order to be the result of double pivoting, must be greater than the downward travel path of the first side of the armature to the substrate to effect contact of the bottom side extension with the substrate. U.S. Pat. No. 5,990,772 distinguishes itself from the prior art by providing the combination of the top and bottom armature extensions to generate the tactile “flop”.

Although some mechanical devices are capable of developing a tactile feel on depression, such devices have the disadvantage of having a spring of such proportions that, in a small size button, the spring prevents backlighting by small LED's or other such lighting sources. Thus, there is a need for tactile response switches that permit backlighting without interfering with the light emission to the user viewable surface without such interference that makes the level of user illumination objectionable. The challenge is especially difficult to achieve when a sealed membrane switch is needed, where substantially an open path must be maintained from the light source to the underside of the membrane. Such sealing membranes are of substantial light diffusivity and/or opacity for small or low power light sources such as LED's. Making a backlighted membrane switch with a tactile response and low profile with low cost has been an elusive and not yet achieved goal in the prior art.

### SUMMARY OF THE INVENTION

The embodiments of the invention include tactile response spring type switches and magnetic connection release switches, especially those switches adapted with backlighting.

Some important objects of the invention are, for backlighted switches:

efficient, and bright illumination of each button,

use of bi or even tri-colored light sources,

a single, separately addressable, light source, associated with each switch or button,

an unbroken surface, that is impermeable to most liquids and dust,

a surface which is easily cleanable, with anything from mild soaps and more aggressive substances containing chlorine and bromine for the control of bacteria, to phenols, for the control of viruses,

a simple design which is less expensive to manufacture,

a long lived light source,

a high cycle count,

explosion proof,

thin and light construction,

good tactile response.

This type of efficient and reliably illuminated switch is particularly useful for applications such asp ortable or fixed medical devices, that regularly need to be cleaned in order to avoid virus or bacteria buildup, military apparatus, which must withstand repeated nuclear and bacteriological decontamination procedures, extremely humid conditions such as those found in the spa & pool industry, automotive control panels which require reliability, cleanability, resistance to liquids and efficient back lighting, explosion-proof applications, which require spark-proof construction for military, chemical or petroleum industries, aerospace industry, with its need for very high reliability, lightweight, thinness, low power consumption and explosion proof construction. In most of these applications it is desirable to be able to provide lighting to either all of the keys at once, or to any selected key(s). For example, on one hand it may be desirable to illuminate all of the keys for night operation and on the other, to illuminate or even change the color, of a particular button, in response to a specific action or function. It is possible with this invention, to achieve both low current draw and a high milicandela rating and with multi or changeable colors.

In the invention, spring type switches locate the spring means effectively below a light source for backlighting a membrane or other cover for the switch. A number of such embodiments are described. A first spring type switch is a spring resting on a first opposing surface abutting a second opposing surface that is the bottom of a piece slotted or indented on its top surface, where the slot is adapted to extend from a surface edge to a more central portion of the top surface, even to the extent of causing the slot to extend across the entire top surface. This then forms a first surface with a spring on it where a second surface rests on the other end of the spring and the top of the button piece continuous with the second surface has a slot on it. From a side support, a small light source like an LED is held extending into the slot so that the LED generally rests within the slot when the button piece is depressed. Depression of the button piece against the spring causes completion of one or more electrical circuits. The button piece can be overlain with alignment pieces and/or a membrane. This first spring type switch therefore removes from obstruction the springs used as in the prior art, where dome type springs in the prior art could not be used effectively with backlighting because in order to maintain the structural integrity of the dome spring, a sufficiently large hole could not be made in the dome top of the dome spring to permit effective backlighting.

A second spring type switch is similar to the first, although the slot on the button piece is reduced in depth and a second button piece has an approximate mirror image of that slot overlaying the first button piece forming a tunnel into which the supported LED or small light source is supported from a side support. The second button piece is a light diffusing material so that interposing it between the light source and the outside of the button or the overlaying membrane interferes with the light transmission only slightly. The dome type springs provide the user a tactile sensation on depression at the point that the dome inverts or is flattened. A tactile switch is formed that allows the user to retain the well known dome type spring incorporating valuable backlighting.

A third spring type switch uses substantially different spring means as compared with the others. A central light transmitting bore is formed in a button piece, where a periphery of the lateral sides of the button piece are integral with flexible side supports holding the button piece apart from a contact surface. The at about the center of bore below the button piece on the contact surface is a small light source. A snappably connectable cap for the button piece preferably connects the button piece with the flexible side supports. As with the other switches, depression of the button piece causes one or more electrical connections to be completed. A membrane may overlay the snappable cap. Thus, a mechanical spring means, i.e., the flexible side supports, for the button piece permit low side profile switch size with low cost assembly. However, the third spring type switches do not for a spring means that give a tactile sensation of having completed the electrical circuit as with the dome type springs and the devices of U.S. Pat. No. 5,990,772. The following embodiments of magnetic switches provide for multiple embodiments of tactile response switches with or without backlighting.

For the magnetic switches of the present invention, the disclosure of U.S. Pat. Nos. 5,990,772 and 4,211,991 is incorporated herein and the teachings of the prior art of the references cited in those applications disclosed herein as defining skill in the art of such switches.

A first magnetic switch is made in a first step by forming a magnetic switch substantially as in FIG. 2 of U.S. Pat. No. 5,990,772, making the top extension substantially higher than disclosed therein and extending through an opening is a support surface so much so that full effective depression can be made of the top extension to accomplish the tactile electrical circuit completion of U.S. Pat. No. 5,990,772 while not substantially depressing the top of the support surface. A button piece is side supported as in the third spring type switches so that a bottom edge of the circumference of the button piece contacts the top of the top extension on depression of the button piece, thereby causing the functions of U.S. Pat. No. 5,990,772 to be effected. However, a small light source is located on the top of the support surface beneath the bore of the button piece so that the light can shine up through the bore and a thin bore covering as in the third spring type switches, thereafter through a covering membrane. Thus, the full magnetic integrity and connection of U.S. Pat. No. 5,990,772 has been maintained in this switch while accomplishing substantially little obstruction to backlighting for a magnetic tactile switch.

A second magnetic switch makes a tactile response possible without the substantial bottom extension of U.S. Pat. No. 5,990,772. It has been found that the recommendation of U.S. Pat. No. 5,990,772 to simply make a hole in the armature to accomplish backlighting results in an switch that has limited effectiveness as a switch but loses the tactile response. It is clear that making a hole in the central part of the armature takes away a substantial part of the magnetic attraction required by the armature to effect the tactile response. Mechanically, removing the magnetic portion of the armature adjacent to the top extension results in effectively eliminating the fulcrum against which the first downward motion, i.e., pushing the bottom extension against the substrate, is achieved. Thus, although a switching function, as well described in U.S. Pat. Nos. 4,400,594 and 4,211,991, may be performed by simply making a big hole in the armature for a substrate mounted light, substantially all the tactile response is lost thereby too. The present embodiment eliminates that loss of tactile response by forming unequal lateral and/or top extensions of the armature as to the first and second sides of the armature to restore the fulcrum effect required to restore the tactile response of the magnetic switch. In doing so, a substrate mounted small light source can shine up through the substantial hole in the armature through a depression force layer and thereafter through a membrane if desired.

A third magnetic switch is similar to that of the second magnetic switch although the armature is roughly square although having a large opening for light transmission to and through a membrane, although the entire inner edge of the hole is raised to form a short cylinder and thereby forming a top edge of the cylinder. Across the top edge of the cylinder is overlain a thin, clear force transmission layer, sufficiently strong so that downward depression of the armature by finger pressure on the force transmission layer presses the armature downward and results in the switch function as for the second magnetic switch.

A fourth magnetic switch is similar to the third magnetic switch although the loosely fitting force transmission layer is replaced with a snap fitting translucent piece, even more certainly assuring that downward pressure on the translucent piece will result in a substantially parallel break away response as in U.S. Pat. No. 4,400,594.

### BRIEF DESCRIPTION OF THE DRAWINGS

FIG. 1 is a cross-sectional view of the first spring switch, illustrating the improved, backlit membrane switch button with tactile feedback using a metal dome armature.

FIG. 1-2 shows an exploded view of the entire assembly of FIG. 1.

FIG. 1-3 shows a detailed 3D view of the active elements of a simple version of a backlit plunger and armature in both OFF and ON positions.

FIG. 2 is a cross-sectional view of a switch, illustrating a two part plunger version of a backlit membrane switch button, with tactile feedback, using a metal dome or armature.

FIG. 2-1 shows a exploded view of the entire assembly.

FIG. 2-2 shows a 3D view of active elements of the plunger embodiments.

FIG. 3 shows a cross-sectional view of a backlit membrane switch, without tactile feedback, with a pillow embossed button and a single, dual purpose circuit layer.

FIG. 3-1 shows an exploded view of the entire assembly.

FIG. 3-2 is an exploded view of a compression or snap fit plunger.

FIG. 3-3 is an example of a unique circuit pad showing a switch and back lighting pad, on the dual purpose circuit layer.

FIG. 4 is a rim embossed version of the switch illustrated in FIG. 3

FIG. 5 shows a cross-sectional view, illustrating a novel back lighting method for a membrane switch, with tactile feedback, using a magnetically coupled armature as in U.S. Pat. No. 5,990,772.

FIG. 5-1 shows an exploded view of the back lighting method.

FIG. 5-2 shows a detailed view of the two part, snap fit plunger and the armature.

FIG. 5-3 shows details of the one part plunger and armature.

FIGS. 6, 6-1 and 6-2 show respectively a cross-sectional view of a switch using a magnetically coupled armature, an exploded view thereof and top and perspective views of the armature.

FIGS. 7, 7-1 and 7-2 show respectively a cross-sectional view of another embodiment of a switch using a magnetically coupled armature, an exploded view thereof and top and perspective views of the armature.

FIGS. 9, 9-1 and 9-2 show respectively a cross section view switch of a package switch similar to the switch of FIG. 6, an exploded view of that switch and an exploded view of the assembled package switch in relation to a prefabricated circuit board for easy installation.

FIG. 10 and 10-1 are respectively cross section and exploded views of a third magnetic switch embodiment.

FIG. 11 shows a cross-sectional view, illustrating the integration of an “individual back light switch module” on a classic membrane switch keypad.

FIG. 11-1 shows an exploded view of an individual backlit switch assembly (Part A & B)

FIG. 11-2 shows a cross-sectional view of a individual backlit switch element.

FIG. 11-3 shows the design of an individual switch circuit with the specific pads.

FIG. 11-4 shows a cross-sectional view, illustrating a backlit keypad using a common circuit and individual magnetic switches (Part A).

FIG. 11-5 shows an exploded view of the elements described before.

FIG. 11-6 illustrate the integration of two complete, individual back light modules (Part A & Part B) on a particular circuit design.

### DETAILED DESCRIPTION OF THE INVENTION

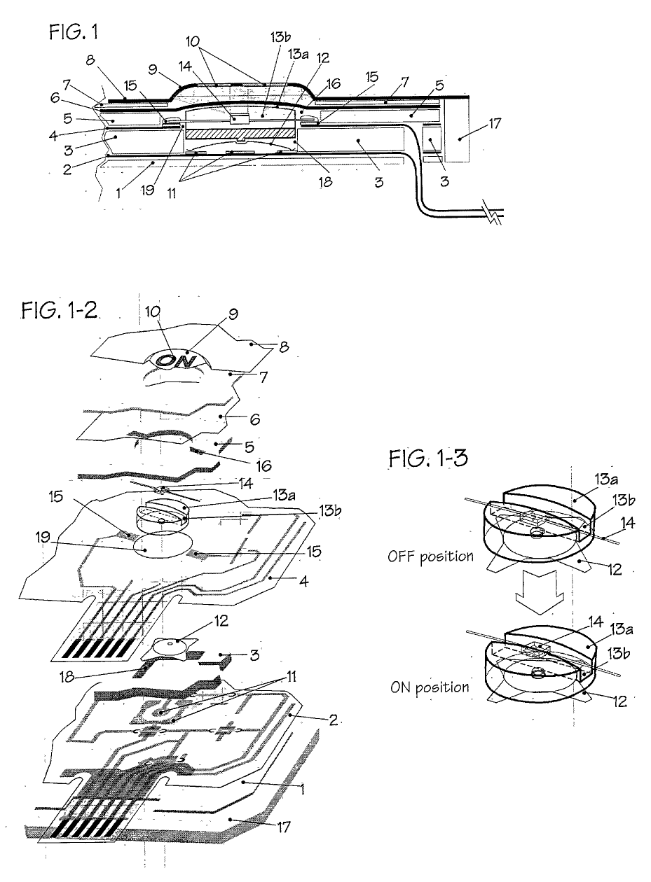

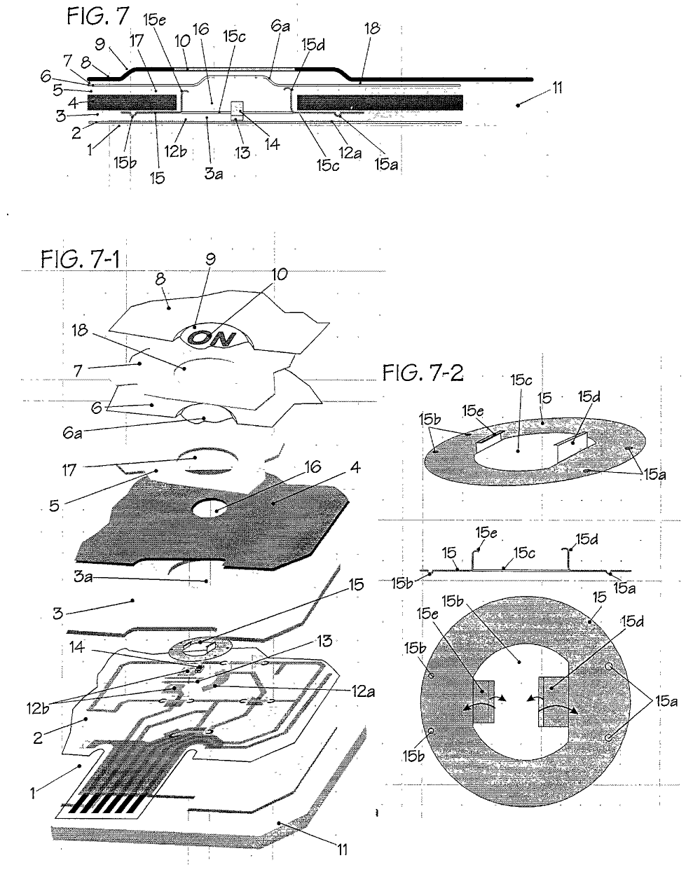

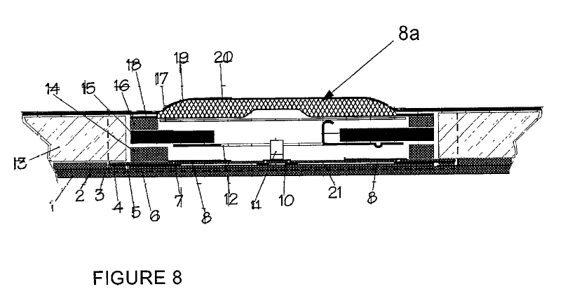

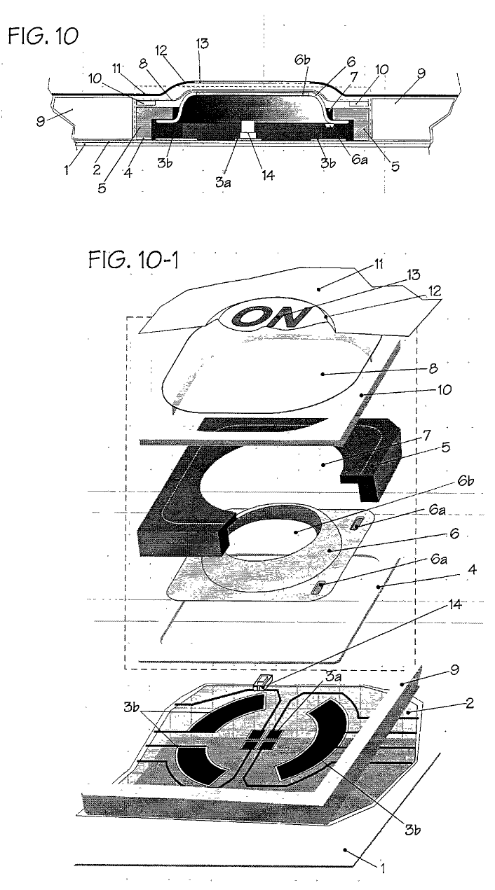

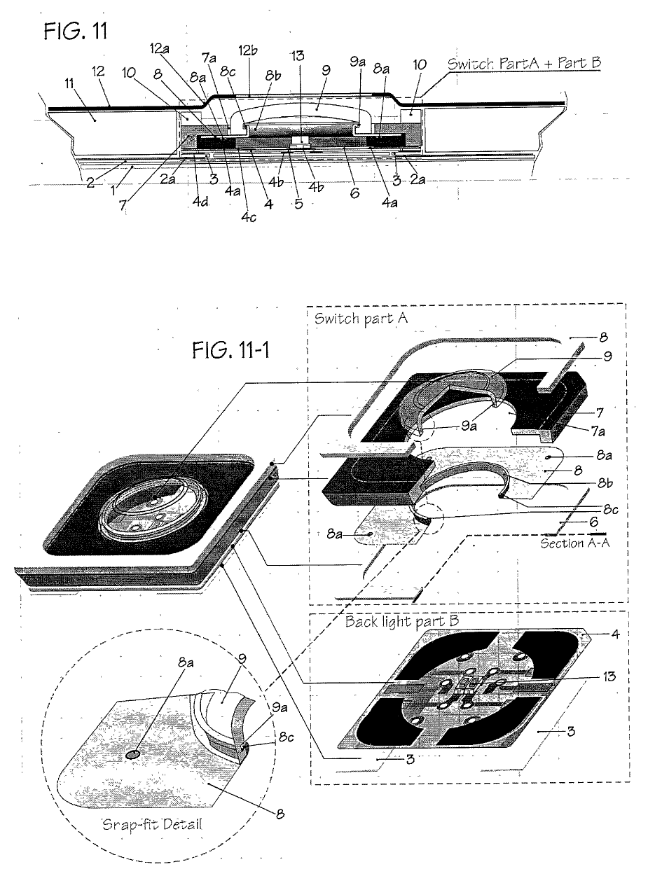

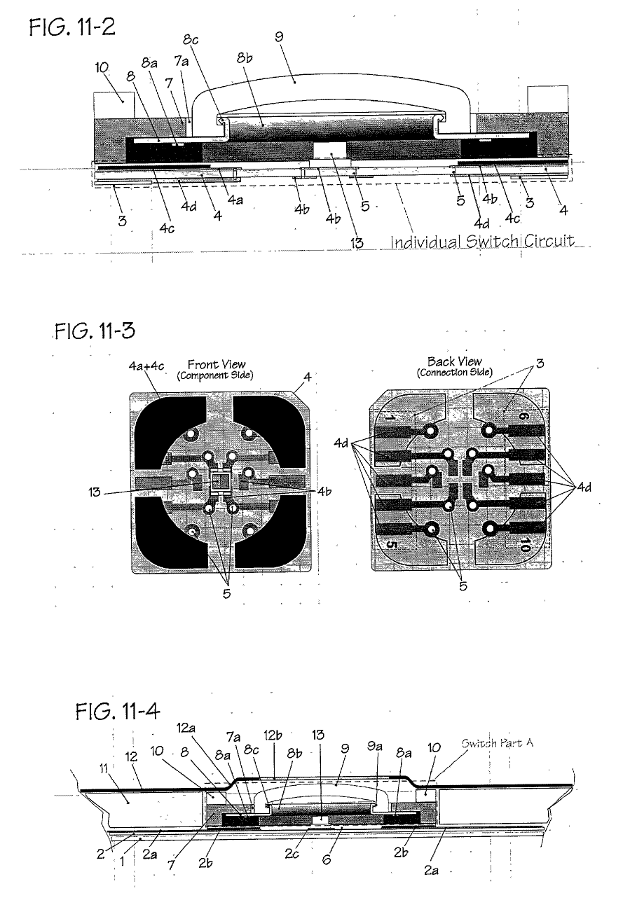

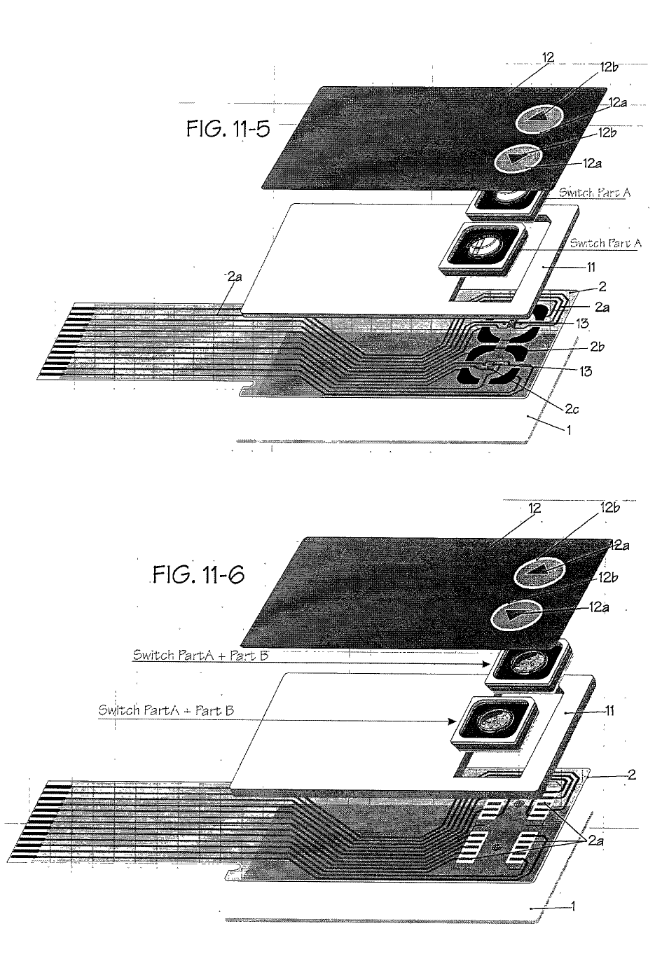

The numbers for the Figures have a first number and some have dashed additions, such as FIG. 11 and FIGS. 11-1 through 11-6. Figures with the same first numbers, such as FIG. 11 and FIGS. 11-1 through 11-6, have item and aspect numbering showing the same item and aspect numbers between them. Figures with different first numbers, such as FIG. 10 and FIG. 11, may have identical item or aspect numbers, although such duplication does not necessarily indicate the same item or aspect between the Figures. Except where indicated, such duplication of numbers between Figures having the same first numbers does not indicate the same item or aspect.

FIGS. 1, 1-2 and 1-3 are a form of the first spring type switch. This switch has a fully slotted top of a button piece, where the LED stretching through the cavity of the slot is protected from the up and down travel of the button piece, described as plunger 13a. FIG. 1 illustrates a cross-sectional view of the first spring type switch as a backlit membrane switch button with tactile feedback.

The active elements of this version, detailed on FIG. 1-3 are: A translucent plunger 13a incorporating a transversal cut or cavity into its top side 13b, actuating a dimpled metal armature 12. The back lighting source 14 is secured within the plunger cavity 13b by supporting electrical connection pads 15 supported and attached to on spacer 3, thus stretching the LED shown as the light source 14 across the space for cavity 13b. Plunger 13a is adapted to travel up or down on depression of overlay 8 therethrough to layer 4 and the top of the button piece plunger 13a without touching or disturbing the attachment of the light source 14. Starting from the bottom up in FIG. 1, the construction and embodiments are as follows: The back adhesive 1 is placed on the lower, non printed circuit side 2. The spacer 3 with its cavity 18 is used to center and to retain the metal armature 12, which is placed over the center of the contact pads 11. The second spacer 5 contains a cut-out 16, specially designed to permit easy plunger travel and to allow a solid electrical contact, between the light source 14 and the pads 15 by causing the armature 12 center to be compressed and contact the center pad 11, on the component side of the light source circuit 4. In locating light source 14 effectively below the top surface of plunger 13a, the lateral emission of the light source 14 travels into plunger 13a and is diffused into it, presenting to the user a more broadly lighted target for pushing. The enviro-seal 17 is a fluid tight outer wall around the entire keypad providing a barrier against dust, dirt and liquids. The adhesive layer 7, is laminated over the diffuser, positioning its hole and the graphic overlay 8 (as a fluid impervious membrane), over the center of the plunger assembly. This liquid and chemical resistant overlay is back printed. The graphic symbols or illuminated text areas 10 for each button, are printed using conventional translucent colored inks. For a better tactile feedback, the membrane of FIG. 1 has a pillow embossed area 9. A thin, transparent force transmitting layer 6 is used to overlay the cavity 13b and the plunger opening in the spacers optionally to reduce the chance that depression of the overlay 8 pressed with a sharp object would permit its point to press through the membrane to the light source 14 and damage it.

The switch of FIG. 1 has the distinct advantage of totally eliminating the interference of the dome type spring to a light source for a pushbutton with easily viewable lighting.

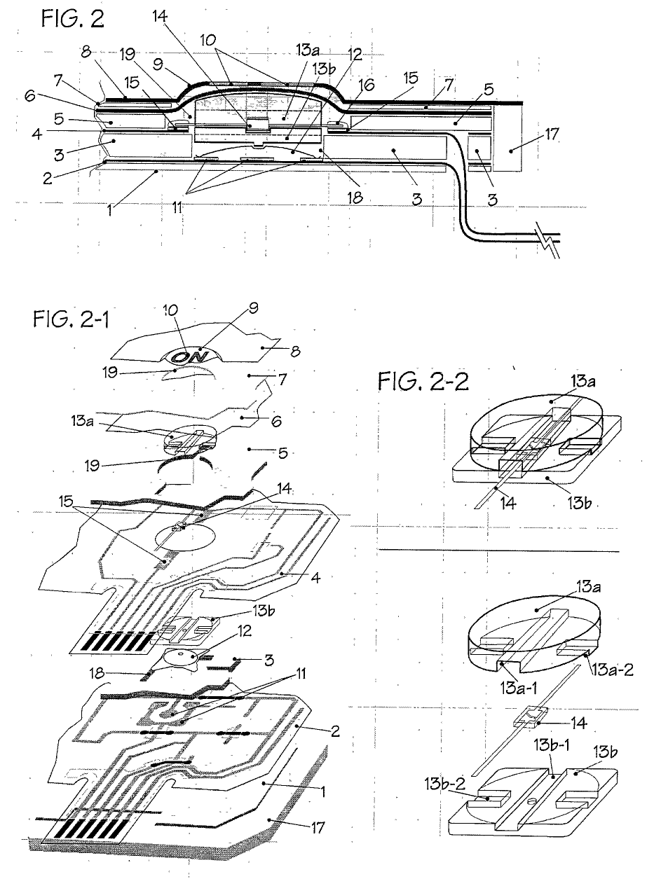

FIG. 2 is a second spring type switch similar to the first spring type switch although with a two part plunger, or button piece, similar to the sealed, backlit, membrane switch with tactile feedback as already described in FIG. 1. The item and aspect numbers of FIG. 2 are substantially those as in FIG. 1, except for the item and aspect numbers used in FIG. 2-2. The plunger adapted to form a tunnel 13a-1/13b-1 with a height about that of the slot in the plunger of FIG. 1. Thus, top element 13a is attached to bottom element 13b at their bottom and top surfaces respectively, where notches 13b-2 and keys 13a-2 interlock for additional security and alignment assistance. Slot 13a-1 is adjacent to slot 13b-1 forming the tunnel 13a-1/13b-1. The objects of this embodiment are accomplished by using a translucent material for the plunger so light source 14 transmits its light up through top element 13a through it so that the light source is in two parts: 13a and 13b-see FIG. 2-2. The two part plunger allows for more flexibility during assembly and due to its unique design, is locked into a specific orientation by virtue of its two elements 13a-2 that will fit in the corresponding recessed elements 13b-2, so as to provide a potentially larger cavity for the light source. The need for layer 6 as in FIG. 1 is eliminated as top element 13a of FIG. 2 performs the protection function for the light source 14.

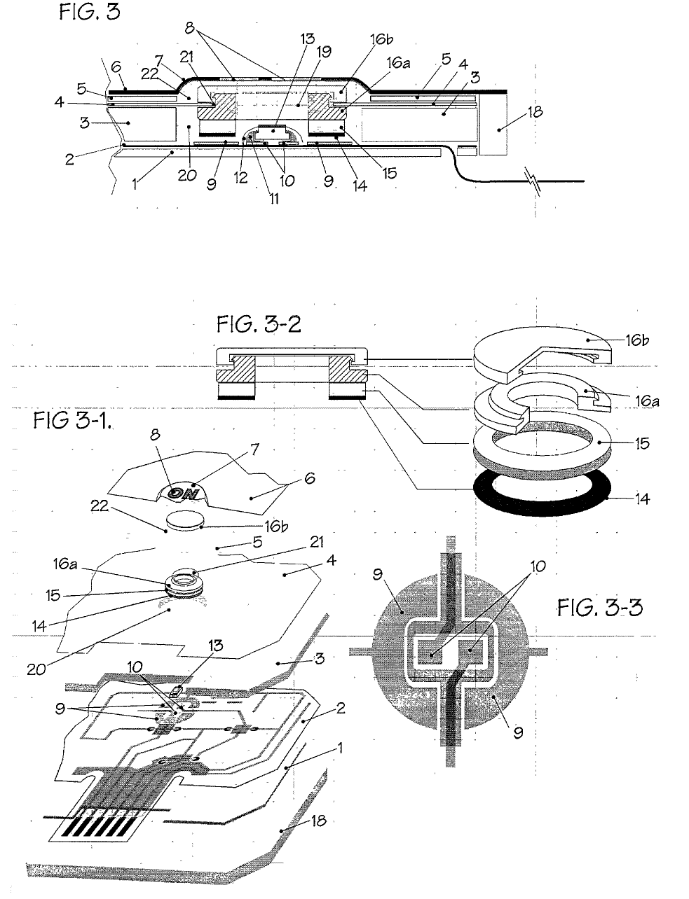

FIGS. 3, 3-1, 3-2 and 3-1 are a third spring type switch with the lateral support spring developed from a flexible layer integral with the button piece. Although the switches of this type are substantially non-tactile, they have a novel backlighting structure and have a potentially low profile. FIG. 3 shows a sealed backlit membrane switch, on a single dual purpose circuit layer. Adhesive 1 is placed on the back of the circuit layer 2, and the spacer 3 with its opening for each button 20, is placed between the circuit and plunger retainer layer 4. It is this layer 4 which provides all the spring action for the snap fit button piece 14 to 16a in its travel down toward the contacts 10 and return to the position shown in FIG. 1, i.e., the open position. The plunger 14 to 16b construction as detailed in FIG. 3-2, has a light diffuser as top plunger part 16b, snap fit plunger part 16a, a compressible layer 15 and a shorting pad 14 all supported from the adjacent spacer 3 by flexible layer 4, thereby replacing a metal armature of the dome type spring. To assemble plunger 14 to 16b, part 16a is drawn into hole 21 in layer 4 so its landing surface abuts layer 4, so that the top plunger part 16b will then be pressed snap fitted into 16a, thereby effectively trapping the Retainer layer, which keep the switch in the “normally open” position. On bottom side of the plunger 16 there is a compressible layer 15, with a conductive surface for the shorting pad 4. By changing the spacer 3 thickness and by using a pillow embossed button area 7 on membrane 6, it is possible to adjust and to obtain a customized travel distance for plunger 14 to 16b. Membrane support spacer 5 raises the level of the membrane 6 so that it's the plane of its bottom side outside the zone 8 is only slightly separated from the top surface of part 16b in the assembled view of FIG. 3.

FIGS. 4, 4-1, 4-2 and 4-3 shows the same item and aspect numbers and substantially same device as in the corresponding device of FIG. 3, although using rim embossing 7 for the button graphic area. It will further be seen that the assembly is simple and relatively inexpensive to fabricate and, because a common layer 4 can support closely adjacent buttons, that the push buttons can be closely grouped together.

U.S. Pat. No. 5,990,772, discloses a push button switch with a magnetically coupled armature as described above. The device of FIGS. 5, 5-1, 5-2 and 5-3 are a first magnetic switch combining the effective functions of the device of FIG. 3 and that of U.S. Pat. No. 5,990,772. Based on this particular switch design, it will now be readily seen, that by adding a sealed gasket all around the membrane and by adding the above mentioned plunger and stationary light source, efficient and addressable back lighting is now possible. It is also possible to have a top surface that is waterproof, and cleanable with cleaning liquids, including Toluene and other very aggressive chemicals for the control and removal of viruses and bacteria.

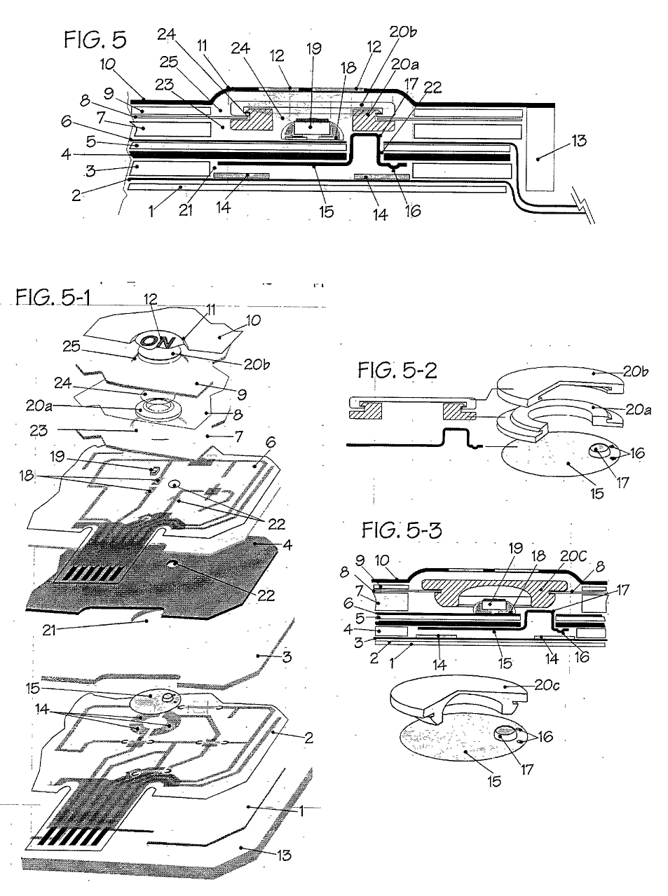

FIG. 5 therefore, illustrates a backlit, sealed, membrane switch button, with accentuated tactile feedback based using a magnetically coupled armature. Starting from the bottom, the adhesive layer 1 is laminated to the non-printed side of the main circuit layer 2. Laminated to the active circuit side of 2 upon which are printed either single or double pole switch pads 14 is a spacer layer 3 into which is cut an opening 21 which separates the switch circuit layer from the magnetic layer 4 and an adhesive layer 5. It is from this point that the backlit section the invention, starts.

In FIG. 5, the second circuit, called the backlit circuit layer 6, contains the circuits and the contact pads 18 to power the light sources 19 and is laminated to the magnetic layer 4. The metal armature 15 is located primarily within spacer opening 21 and its actuating button 17 protrudes through an aperture 22 in the magnetic 4, adhesive 5 and backlit circuit layers 6. It should be noted that the lower surface of the armature has a pair of a dimples embossed into it as bottom extensions 16, required for the dual pivoting action described in U.S. Pat. No. 5,990,772. The extensions 16 are shown separated from the switch pads 14 when open, but they are in contact when the switch is closed, as the magnetic layer 4 normally holds the armature 15 up against the underside of that layer. A spacer 7, is laminated to the top of the backlit circuit layer 6, note the opening 23. The retainer layer 8 into which holes have been made, and into which a translucent plunger is fitted, is then laminated onto the spacer 7. The plungers are held in both the vertical and horizontal planes however, since the retainer layer 8 is thin and therefore flexible, a certain amount of vertical movement is possible when the button is pressed. The pillow embossed buttons 11 of the graphic overlay 10, along with an adhesive layer 9 complete the assembly for the upper portion.

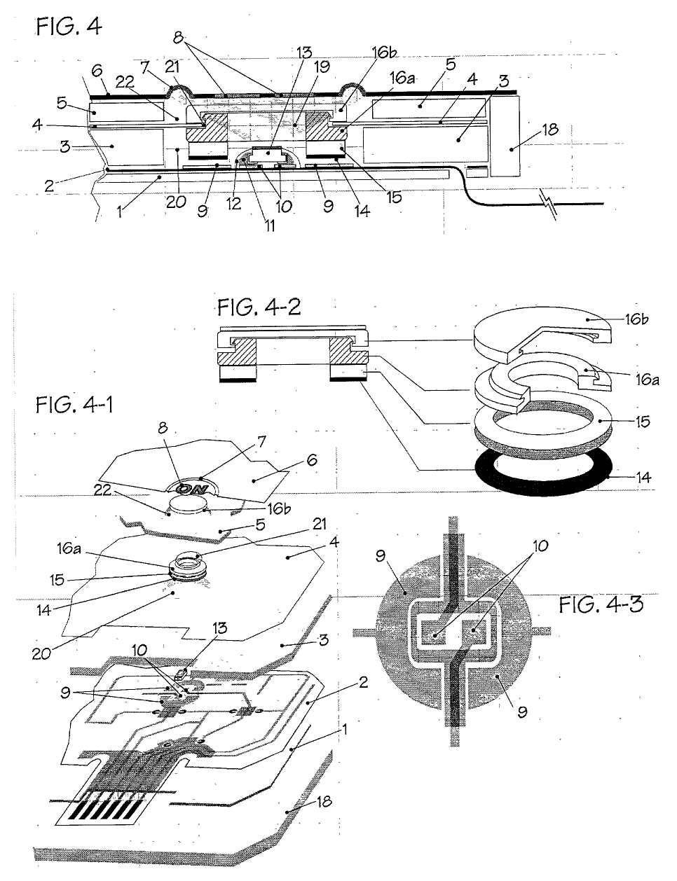

The clear plastic plunger 20 (shown as translucent snap fit pieces 20a and 20b of FIGS. 5 and 5-2 and as translucent piece 20C of FIG. 5-3) is attached by the aperture 24, to the plunger retainer layer 8 (equivalent to the flexible spring layer of the device of FIGS. 3 and 4), by pressing together two plunger parts 20a and 20b or snap fitting a solid plunger 20C into the hole 24 in the retainer layer 8. As detailed in FIG. 5-2 and 5-3, the internal space or cavity of the 20a, b & c parts, are designed to permit the vertical travel of the plunger, without touching the light source 19 embedded on the circuit 6. When the user pushes a pillow embossed button 11, the graphic overlay layer 10 acts upon the plunger 20, which in turn acts upon the actuating button 17 (the upper extension of U.S. Pat. No. 5,990,772) of the metallic armature 15, that makes contact with the two shorting pads 14 allowing electrical current to flow. Button 17 is adapted to have a height above the top surface of layer 5 so that its depression by the bottom of plunger 20 causes the functions of tactile response described in U.S. Pat. No. 5,990,772. The general function of the device of FIG. 5 is to structurally separate the action of the magnetic switch of U.S. Pat. No. 5,990,772 to a location below the light source so that no hole is required in the armature, as suggested in that patent, to give lighting beneath the membrane graphic layer 10 guiding the user in pressing that button, where printing 12 indicates to the user the general function of the switch.

The LED or other light source 19 is shown proximally located and in close proximity to, the button's surface graphic overlay 10, allowing light to pass virtually undiminished through the graphic overlay while being individually addressable. By the addition of one or more circuits to the backlit circuit layer, a bi or tri-color LED or other light source may be used. The fact that there is no need to pierce the graphic overlay 10, and by the addition of special sealants around the entire edge of the membrane switch, the switch becomes highly liquid and dust resistant. By making the graphic overlay layer out of specific plastics that resist strong cleaners, acids and other aggressive materials, it is possible to clean the outer surface of the switch to the standards required by the medical and military communities.

A second spring type switch is shown in FIGS. 6, 6-1, and 6-2. Items and aspects with the numbers 1-4, although the top of layer 1 is adapted to have the light source 14 mounted at pad 13. Hole 16 is formed in spacer 3 and a larger hole is formed in spacer 5 to accommodate the downward flexion of the layer 6 as described below. An armature 15 is adapted to have an irregular shaped planar surface with optional downward dimples 15a and 15b and an upward extension 15d at or near the hole 15c. The planar surface has a hole 15c with sufficient size so that the illumination from light source 14 shines upward through it and through transparent layer 6 which is supported by spacer layer 5, continuing up through graphic layer 8. Layer 6 is made of a thin transparent and partly flexible material having an upward indentation 6a held between the bottom side of the layer 8 and the top of extension 15d in a manner so that depression of layer 8 at button zone 9 (with printing 10) causes the non-indented surface of layer 6 to press against the top of extension 15d. The armature 15 then is caused to fall away from layer 4 at the side of armature 15 having extensions 15a so that the armature 15 abuts contacts on layer 1 beneath it. Immediately after that abutting action, the other side of armature 15, the side with extensions 15b, falls to abut the contacts on layer 1. This dual pivoting action is produced not due to the presence of bottom extensions of the armature as in U.S. Pat. No. 5,990,772, but rather from the difference in magnetic surface area in the planar surface of armature 15 as shown in the side having extensions 15a as opposed to the side having extensions 15b. The surface area of the 15a side is substantially less than the surface area of the 15b side of the planar surface, causing the 15a side to release first, further urged to such a first release by the location of extension 15c on that 15a side. Sidewall 11 is a fluid tight enclosing means. Contacts 12a and 12b are those contacts connected by action of pushing the button of this device.

The device of FIGS. 7, 7-1 and 7-2 (and their aspect and item numbers) are substantially those of FIGS. 6, 6-1 and 6-2, except that an additional extension 15e is formed at the 15b side of armature 15. The extension 15e is preferably less in height than extension 15d so that the dual pivoting action is preserved.

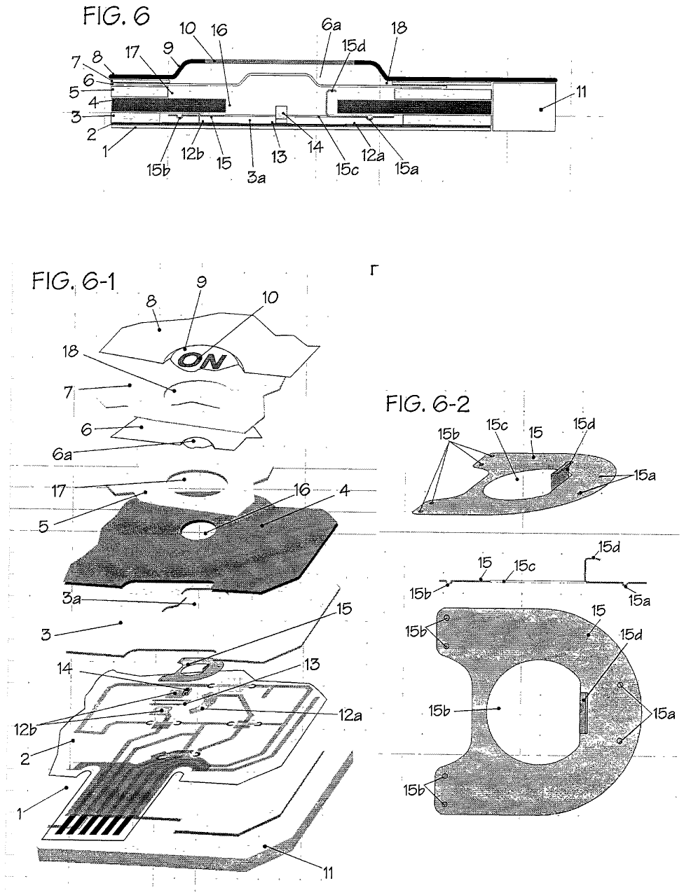

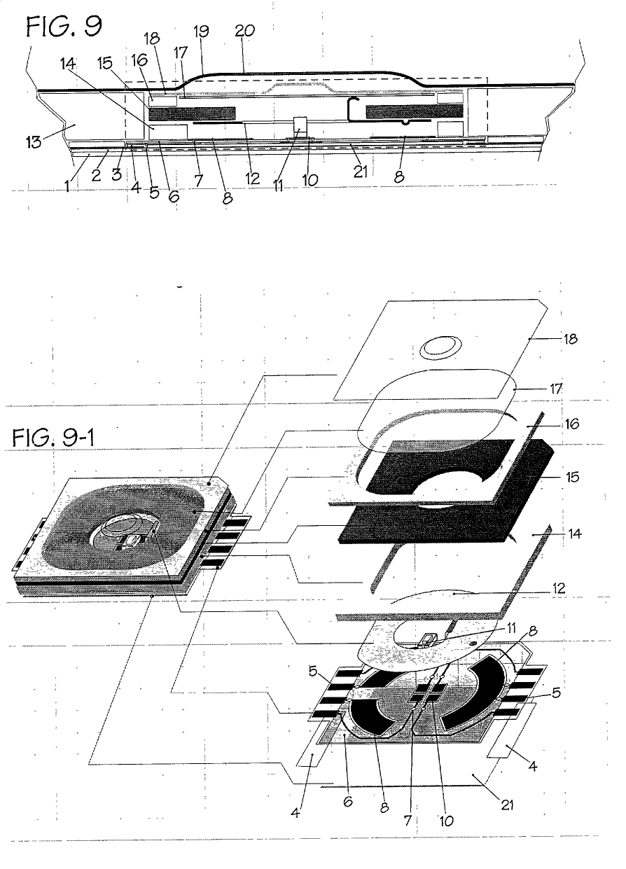

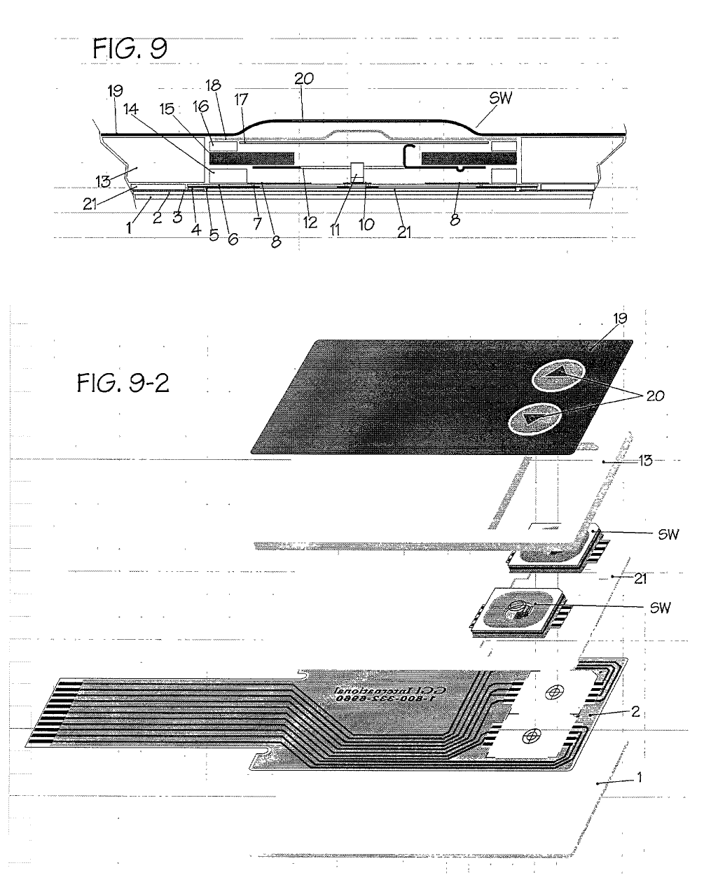

The device of FIGS. 9 and 9-1 are a second magnetic switch as in FIG. 6, although, as for the devices of FIGS. 10 and 11 as well, an easily installed package switch is shown that requires for installation only circuit board printing and adhesive application of the switch package, then forming a membrane overlay above the circuit board and switch package. The package switches are a significant advance in the art of manufacturing and applying low profile magnetic switches.

A discussion of the device of FIG. 11 is made first as exemplary of the package switch concept combined with a tactile switch.

FIG. 11 is a fourth magnetic switch with a magnetic armature snap fitted to translucent cap over a hole combination acting somewhat like the devices of FIG. 10. FIGS. 11 and 11-1 to 11-6 describe two package switches. For this set of Figures, FIGS. 11-4 and 11-5 have different item and aspect numbers, in describing a first package switch, as to numbers 2 and 2a-2c.

Each package switch has a switch part as shown in FIG. 11-2. The switch part has at least magnet 7, an armature 8, cap 9, and spacer 10. It is within skill in the art of this disclosure to form magnet 7 mostly of a polymer and secure therein a magnet at the required interface of armature 8 and magnet 7. It is intended that adhesive attachment of magnet 7 and spacer 10 and assembly of an armature 8 and cap 9, followed by magnetic connection (as in FIG. 11-2) of armature 8 to magnet 7 will permit separate manufacture and storage of this switch part as a subassembly. The switch part in the FIGS. 11 and 11-1 to 11-6 is shown as Switch Part A.

The first package switch has a backlight part shown in FIG. 11-4 and 11-5. The backlight part has adhesive layer 1, circuit and backlight layer 2, armature contacts 2a, light source pads 13 and light source 13. Fabrication of the backlight part for the first package switch can be made without concurrent assembly of the switch part, so that the many circuit location requirements that result from having to make specific products can be engineered and made with consideration only for providing the backlight part with a support layer 11 as in FIG. 11-5, whereby an opening is formed in layer 11 so that the switch part can be adhesively connected to layer 2 by adhesive pad 6 between the bottom side of magnet 7 and the top side of layer 2. The membrane layer 12 can be overlain and attached to the top of layer 11 and layer 10, such that pressing the button portions 12a and indicated by printed sections 12b results in tactile response circuit activation.

The second package switch removes substantially all the switch and backlight parts to an insertable assembly similar to that of the first package switch. The second package switch has a backlight part shown in FIG. 11-3. The backlight part (identified in the FIGS. 11, 11-1 and 11-6 as Part B) has a support layer 4 that is imprintable and adapted to receive and support the other aspects of the backlight part. Layer 4 has on the connection side anisotropic adhesive pads 4d which are adapted to be pressed upon and effectively attach to pads 2a of layer 2 as shown in FIGS. 11-5 and 11-6, thereby completing effective circuit connections from the package switch to the circuit board. The component side of layer 4 has armature contact pads 4a and 4c, light source 13 mounted in a central location and electrically connected with the contact pads via printed connections 4b. This backlight part is attached to the switch part as shown in FIG. 11 and 11-2. The combination shown in FIG. 11-2 is the second package switch that is insertable into the opening in layer 11 as in FIG. 11-6 so that it is adhered and electrically connected with the pads 2a.

Anisotropic conductive adhesives (the “Z-axis”) are those such as 3M Electrically Conductive Tape 9703. This is a pressure sensitive adhesive (PSA), easy to use in assembly operation without any thermal curing. Another PSA is “hot melt” paste from ASAHI Chemical Research Laboratory. As a PSA, Coating paste “CR-40HM” is screenprintable and very useful for some particular projects. Conductive “Zebra” strips could also be employed

FIG. 11-2 shows a cross-sectional view and FIG. 11-1 shows an exploded perspective view of second package switch. In further discussion of the aspects of FIGS. 11 and 11-1 to 11-6, Switch Part A has a ferromagnetic armature 8 and a translucent actuator 9. These two elements snap-fit together, as in the “snap-fit” detail in FIG. 11-1. When the membrane covered button is pressed, the armature 8 will travel parallel to the surface it contacts in FIG. 11, not pivotally. When the four dimples 8a contact the pad, circuit connections are closed. It has been found that although the armature 8a release from magnetic connection produces a tactile response, the release action is, and must be to effect closing of electrical connections simultaneously, parallel to the surfaces between which it is located.

As in FIG. 11, after the actuation, i.e., button pushing and contact completion, the button is released and without pressure on it, the armature returns to the initial normally open position in magnetic connection with the surface above the contacts. This movement is possible using a strong magnet 7. This part could be an injected molded element having an aperture 7a to permit the movement of the translucent part of the armature 9. The tactile “click” of the switch is achieved when the armature 8 release from contact with magnet 7 and/or on the return connection with magnet 7. The actuation force is a function of the attraction strength of the magnet 7.

For the first package switch, adhesive layer 6 fixes Switch Part A on the desired position of the circuit pad. The electrical connections for the backlight part of FIG. 11-3 may be copper traces on Kapton or FR4 substrate, or printed conductive silver ink on polyester substrate used in membrane switch technology. The front view (component side) of the backlight part is positioned under the switch part when connected thereto. On the component side in FIG. 11-3, pads 4a and 4c may be screen printed silver ink 4a covered by a protective carbon layer 4c. The LED's or light source pad 4b is placed in a central area for backlighting the membrane button. The circuit elements placed on the component side, pass over “trough holes” 5 technique on the back side.

The integration of a second package switch into a classic membrane switch is illustrated in FIG. 11-6. Starting from the bottom, the back adhesive 1 is laminated on the non printed side of the common membrane switch circuit 2. The design of this circuit has to include the “standard pads” 2a similar to the button circuit 4, permitting the integration of the “individual backlit cells” into the common circuit according to the desired pin-out. Part of the membrane assembly, the foam layer 11 compensate the button thickness.

For keypads without back lighted keys, only the switch part may be used. For backlight keypads another design option (see FIG. 11-5) is to put all electrical pads for switches and light sources on the same circuit of the membrane switch. This time only the switch part A are placed on the circuit to complete the backlit keypad.

It will now be appreciated in FIGS. 9, 9-1 and 9-2 that a package switch similar to the second package switch is formed with the second magnetic switch of FIG. 6. The item and aspect numbers are similar to those of FIG. 6 as to the switch part. Reference is made to FIG. 11 and its description for discussion of the second package switch. FIG. 9 has connections 5 that are adapted to be electrically connected with the connections of layer 2 in FIG. 9-2 in the zone 4 of FIG. 9-1.

A third magnetic switch is shown in FIGS. 10 and 10-1. This magnetic switch is adaptable as a switch part in the first or second package switches. FIG. 10 shows a magnet 5 and spacer 10 as in the magnet 7 and spacer 10 of FIG. 11. The armature 6 of FIG. 10 has a roughly square planar part adapted to releasably connect with magnet 5. The planar part has a hole 6b adapted to let illumination from light source 14 shine up through it, through transparent, rigid layer 8 and thereafter through the membrane layer 11. A uniform upward extension from and all around the edge of hole 6b forms a contact edge or surface at the top of the extension that is contacted with the layer 8. Pressing on the button part 12 causes layer 8 to transmit its force to the top of the upward extension of armature 6, thereby causing armature 6 to fall away from magnet 5 substantially parallel to the connection surface of magnet 5. Adhesive layer 1 connects with circuit layer 2 on which is mounted light source 14 at pad 3a. Layer 2 also comprises contact pads 3b.

In an alternate embodiment of the present invention, combining aspects of the devices of FIGS. 6 and 9, a modified element is the top zone of the switch. Between the activator layer (6 of FIG. 6 or 18 of FIG. 9) and pillow embossed area (8 of FIG. 6 or 19 of FIG. 9) of the graphic overlay, a clear epoxy or silicone medium is injected in fabrication to substantially fill a void that would usually exist there for the devices of FIGS. 6 and 9. FIG. 8 shows the device of FIG. 9 having a connection elastomer 8a between area 19 and layer 18 indicating the presence of that cushion layer. Elastomer 81 is preferably clear to act as a diffuser as well as a cushion, improving light scattering along with additional bracing for a tactile response.

The above design options will sometimes present the skilled designer with considerable and wide ranges from which to choose appropriate apparatus and method modifications for the above examples. However, the objects of the present invention will still be obtained by that skilled designer applying such design options in an appropriate manner.

We claim:

1. An electrical switch comprising:
(a) a substrate having a pair of spaced apart switch contacts on a top surface;
(b) a substantially U-shaped armature defining a substantial first hole or U-shaped opening comprising magnetic material magnetically maintained above the switch contacts by one or more magnets supported from a support layer, the bottom U-part of the U-shaped armature comprising an upward extension extending upward through first hole above the support layer through a second hole in the support layer;
(c) an activation layer overlaying the top of the upward extension adapted to permit downward pressure by a user to cause the armature to first contact one of the switch contacts and upon further pressure by the user to contact the second switch contact; and
(d) a light support on the substrate and adapted to shine up through the first and second holes and the activation layer so that a user may see an illuminated switch.
